(19) United States
(12) Patent Application Publication
(10) Pub. No.: US 2004/0145608 A1
(43) Pub. Date: Jul. 29, 2004

(54) User interface for conducting chats over a network

(75) Inventors: Sean Fay, Ipswich, MA (US); Glen E. Salmon, Amesbury, MA (US); Dan J. Smith, Stevens Point, WI (US); Lynn L. Wu, Castro Valley, CA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/350,491

(22) Filed: Jan. 24, 2003

(51) Int. Cl. G09G 5/00

(52) U.S. Cl. 345/758; 345/823; 345/777

(57) ABSTRACT

Under the present invention, a user interface for conducting chats over a network is provided. The user interface includes a list tab for revealing a list of receiving chat partners and a status of each of the receiving chat partners, a status tab for selecting a status of a sending chat partner, and a chat tab for revealing information pertaining to a set of active chats between the sending chat partner and the receiving chat partners. In addition, indicators could be provided on the tabs to provide various functionality/information

### BACKGROUND OF THE INVENTION

1. Field of the Invention

The present invention general relates to a user interface for conducting chats over a network. Specifically, the present invention provides a tab-based user interface that makes optimal use of display space.

2. Background Art

As the use of computer technology becomes more prevalent, computer users are increasingly communicating with each other in a network environment (e.g., over the Internet). One popular form of such communication is known as “chatting.” In general, a chat is communication forum that allows users (i.e., “chat partners”) to exchange text and/or graphics as if they were communicating in person. Chatting differs from electronic mail in that a chat sender's message is immediately displayed to a recipient upon being sent. That is, there is little or no perceived delay during the transmission of the message, and no “in-box” to be checked.

To date, several different types of forums exist whereby users can conduct chats. One example is a chat room, which allows multiple chat partners to log-in and communicate with each other simultaneously. In a chat room, all chat partners present can view all communications being made. Another example is instant messaging (e.g., AOL Instant Messaging), which allows users to communicate with each other on a one-on-one basis. In the case of instant messaging, a sending chat partner can hold multiple individual chats with receiving chat partners. This allows the content exchanged with one receiving chat partner to be kept private from the other receiving chat partners.

This rising growth of popularity in chat technology has caused many hand-held device producers to render their devices network and chat capable. Specifically, today, virtually all new personal digital assistants, cellular telephones, pager devices, etc. are as capable of communicating over a network as a personal computer. Unfortunately, with hand-held devices, display (screen) space is often limited. Specifically, due to the inherent portability of hand-held devices, displays of minimal size are often utilized. Such displays can greatly affect the efficiency and manner in which a hand-held device user can operate the device. Moreover, the lack of display space becomes a problem when the hand-held device contains a program (e.g., a chat program) whose interface was designed for a full-size display (e.g., a 17″ monitor). In such a case, the interface typically does not function as originally intended, and often contains obstructed sections and buttons.

In view of the foregoing, there exists a need for a user interface for conducting chats over a network. Specifically, a need exists for a user interface that optimizes display space on a computerized system such as a hand-held device. A further need exists for the user interface to include a set (i.e., one or more) of tabs that provides access to desired information and functions. Still yet, a need exists for various indicators to be provided on the tabs.

### SUMMARY OF THE INVENTION

In general, the present invention provides a user interface for conducting chats over a network, as well as a system, method and program product for generating the user interface. Under the present invention, the interface includes a list tab for revealing a list of receiving chat partners, and a status of each of the receiving chat partners. The interface also includes a status tab for selecting a status of a sending chat partner. For example, the status tab allows the sending chat partner to indicate whether they are “away” from the device, and to designate a suitable “away” message. The status tab could also include a status indicator that identifies the selected status of the sending chat partner. A chat tab is also provided on the user interface for revealing information pertaining to a set (i.e., one or more) of active chats currently being held between the sending chat partner and one or more receiving chat partners. The chat tab typically includes a set (i.e., one or more) of chat indicators that each correspond to an active chat. This tab-based user interface can be used to conduct multiple active chats. Accordingly, the user interface of the present invention allows display space on computerized systems, such as hand-held devices, to be optimized.

According to a first aspect of the present invention, a user interface for conducting chats over a network is provided. The user interface comprises: (1) a chat tab for revealing information pertaining to a set of active chats between a sending chat partner and a set of receiving chat partners, wherein the chat tab includes a set of chat indicators corresponding to the set of active chats.

According to a second aspect of the present invention, a user interface for conducting chats over a network is provided. The user interface comprises: (1) a list tab for revealing a list of receiving chat partners and a status of each of the receiving chat partners; (2) a status tab for selecting a status of a sending chat partner, wherein the status tab includes a status indicator for indicating the status of the sending chat partner; and (3) a chat tab for revealing information pertaining to a set of active chats between the sending chat partner and the receiving chat partners, wherein the chat tab includes a set of chat indicators corresponding to the set of active chats.

According to a third aspect of the present invention, a system for generating a user interface for conducting chats over a network is provided. The system comprises: (1) a list system for generating a list tab for revealing a list of receiving chat partners and a status of each of the receiving chat partners; (2) a status system for generating a status tab for selecting a status of a sending chat partner; and (3) an activity system for generating a chat tab for revealing information pertaining to a set of active chats between the sending chat partner and the receiving chat partners.

According to a fourth aspect of the present invention, a program product stored on a recordable medium for generating a user interface for conducting chats over a network is provided. When executed, the program product comprises: (1) program code for generating a list tab for revealing a list of receiving chat partners and a status of each of the receiving chat partners; (2) program code for generating a status tab for selecting a status of a sending chat partner; and (3) program code for generating a chat tab for revealing information pertaining to a set of active chats between the sending chat partner and the receiving chat partners.

According to a fifth aspect of the present invention, a method for generating a user interface for conducting chats over a network is provided. The method comprises: (1) generating a list tab for revealing a list of receiving chat partners and a status of each of the receiving chat partners; (2) generating a status tab for selecting a status of a sending chat partner; and (3) generating a chat tab for revealing information pertaining to a set of active chats between the sending chat partner and the receiving chat partners.

Therefore, the present invention provides a user interface for conducting chats over a network, as well as a system, method and program product for generating the interface.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computerized system having a chat system/program for generating a user interface according to the present invention.

FIG. 2 depicts an exemplary user interface according to the present invention.

FIG. 3 depicts the user interface of FIG. 2 upon selection of the list tab.

FIG. 4 depicts the user interface of FIG. 2 upon selection of the status tab.

FIG. 5 depicts the user interface of FIG. 2 upon selection of the chat tab.

FIG. 6 depicts the user interface of FIG. 2 as used to conduct a chat.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a user interface for conducting chats over a network, as well as a system, method and program product for generating the user interface. Under the present invention, the interface includes a list tab for revealing a list of receiving chat partners, and a status of each of the receiving chat partners. The interface also includes a status tab for selecting a status of a sending chat partner. For example, the status tab allows the sending chat partner to indicate whether they are “away” from the device, and to designate a suitable “away” message. The status tab could also include a status indicator that identifies the selected status of the sending chat partner. A chat tab is also provided on the user interface for revealing information pertaining to a set (i.e., one or more) of active chats currently being held between the sending chat partner and one or more receiving chat partners. The chat tab typically includes a set (i.e., one or more) of chat indicators that each correspond to an active chat. This tab-based user interface can be used to conduct multiple active chats. Accordingly, the user interface of the present invention allows display space on computerized systems, such as hand-held devices, to be optimized.

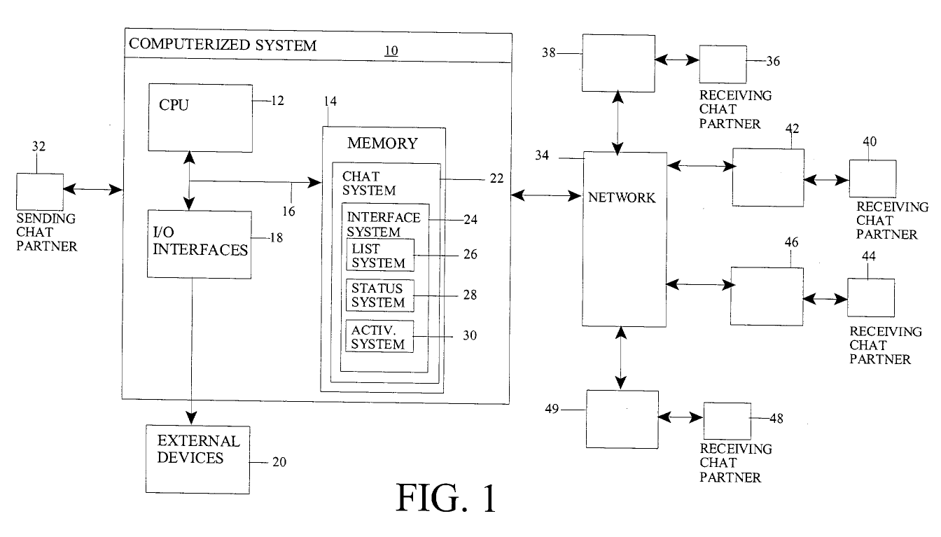

Referring now to FIG. 1, a computerized system 10 is shown. In general, computerized system 10 is intended to be any type of computerized system that can communicate with computerized systems 38, 42, 46 and 49 over network 34. For example, computerized system 10 can be a hand-held device (e.g., personal digital assistant, cellular phone, pager device, etc.) or a larger-sized computer system (e.g., laptop, personal computer, workstation, server, etc.). To this extent, it should be appreciated that although the present invention is intended to optimize the display space for a hand-held device, its teachings could be implemented on any type of computerized system. In addition, it should be understood that the term “chat” as used herein is intended to refer to any type of network-based communication between computer users. Examples include, among others, chat room communications, instant messaging, cellular telephone short messaging, etc. It should also be understood that although the generation of a tab-based user interface will be described in a chat environment, the teachings described herein could be used to generate a tab-based user interface for any type of program and/or environment.

Computerized system 10 is typically used by sending chat partner 32 to conduct active chats with one or more receiving chat partners 36, 40, 44 and 48. As such, receiving chat partners 36, 40, 44 and 48 will utilize computerized systems 38, 42, 46 and 49 which communicate with computerized system 10 over network 34. Network 34 is intended to represent any type of network over which computerized systems 10, 38, 42, 46 and 49 can communicate. For example, network 34 can be the Internet, a wide area network (WAN), a local area network (LAN), a virtual private network (VPN) or other type of network. To this extent, communication between computerized systems 10, 38, 42, 46 and 49 can occur via a direct hardwired connection (e.g., serial port), or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server. It should be understood that the quantity of receiving chat partners 36, 40, 44 and 48 shown in FIG. 1 is purely illustrative and is not intended to limit the teachings of the present invention in any way.

As shown, computerized system 10 generally includes, central processing unit (CPU) 12, memory 14, bus 16, input/output (I/O) interfaces 18 and external devices/resources 20. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor/display, facsimile, pager, etc. To this extent, it should be appreciated that if computerized device 10 is a hand-held device, the display would be contained within computerized system 10, and not as an external device 20 as shown.

Bus 16 provides a communication link between each of the components in computerized system 10 and likewise may comprise any known type of transmission link, including electrical, optical, wireless, etc. In addition, although not shown, additional components, such as cache memory, communication systems, system software, etc., may be incorporated into computerized system 10. It should be understood that computerized systems 38, 42, 46 and 49 typically include components (e.g., CPU, memory, etc.) similar to computerized system 10. Such components have not been shown for brevity purposes only.

Shown in memory 14 is chat system 22, which can be any program that provides chat capabilities. For example, chat system 22 could be a program similar to AOL Instant Messenger. Within chat system 22 is interface system 24, which will generate a user interface according to the present invention. Specifically, interface system 24 includes list system 26, status system 28 and activity system 30 that will generate a tab-based user interface that optimizes display space on computerized system 10.

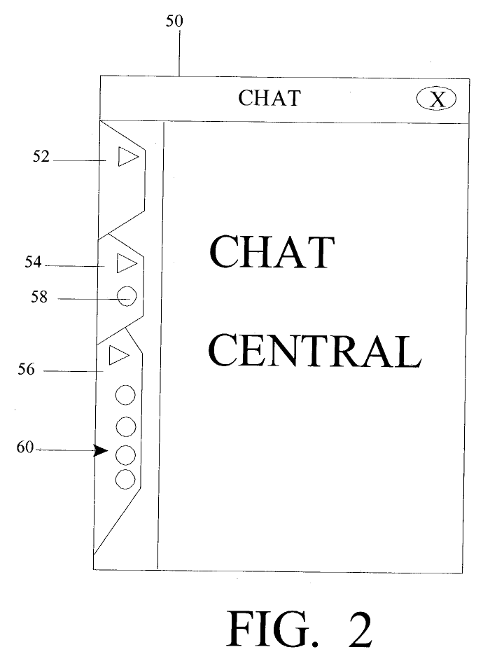

Referring now to FIG. 2, user interface 50 as generated by interface system 24 is shown. As depicted, user interface 50 includes list tab 52, status tab 54 and chat tab 56. As will be further described below, unlike other interfaces, a single user interface 50 is used for conducting multiple active chats. That is, for example, if sending chat partner 32 is actively engaged in four chats, only a single user interface 50 is required to perform all necessary functions. In other systems, four separate chats generally require four separate chat interfaces, and possibly a fifth interface to perform underlying functions (e.g., information lookup, etc.).

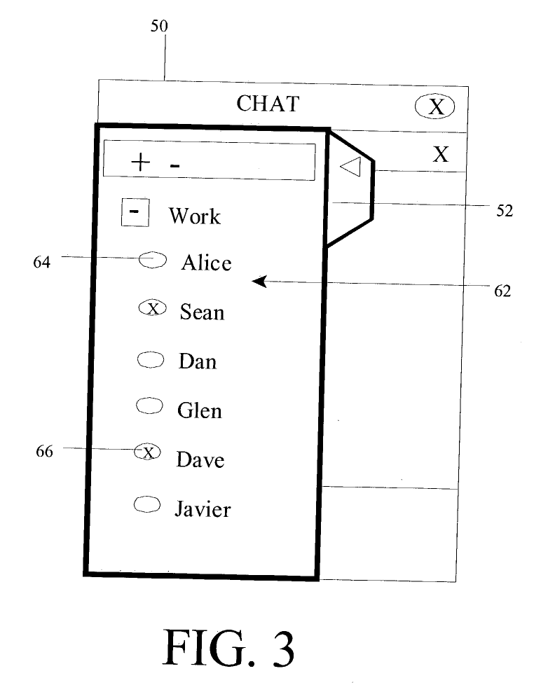

In any event, list tab 52, status tab 54 and chat tab 56 of user interface 50 are typically generated by list system 26, status system 28 and activity system 30 of FIG. 1, respectively. As shown in FIG. 3, selection of list tab 52 by sending chat partner 32 will cause list tab 52 to “expand” and reveal a list of receiving chat partners 62. In the example shown in FIG. 3, list of receiving chat partners 62 corresponds to a group of coworkers of sending chat partner 32. To this extent, list 62 is similar to a “Buddy List” under AOL Instant Messenger. Each receiving chat partner in list 62 has a status indicator. The status indicators identify whether each receiving chat partner is, for example: (1) on-line and able to receive communications; (2) on-line but away from his/her computerized system; (3) off-line entirely; (4) idle; or (5) not to be disturbed. For example, indicator 64 indicates that receiving chat partner “Alice” is on-line. Accordingly, sending chat partner 32 can transmit a communication to her. Conversely, status indicator 66 indicates that receiving chat partner “Dave” is off-line, and cannot receive communications. Thus, the receiving chat partners in list 62 that are currently on-line (e.g., Alice, Dan, Glen and Javier), could correspond to receiving chat partners 36, 40, 44 and 48 of FIG. 1 (although this need not be the case).

It should be understood that all indicators described herein are shown having a particular form for illustrative purposes only, and that many variations could be implemented. For example, status could be denoted according to colors (e.g., a blue colored status indicator could mean that a particular chat partner is on-line, a white colored status indicator could mean that a particular chat partner is on-line but away, while a red colored status indicator could mean that the particular chat partner is off-line). Moreover, all indicators described herein could be animated. For example, an indicator could be made to flash/pulse.

Referring back to FIG. 2, positioned on status tab 54 is status indicator 58, which indicates the status of sending chat partner 32 (as opposed to status indicators 64 and 66 of FIG. 3, which pertain to receiving chat partners). Status indicator 58 allows sending chat partner 32 to quickly ascertain his/her “chat” status. To this extent, the appearance of status indicator 58 can be changed/altered similar to the status indicators used in list 62 of FIG. 3. For example, a blue colored status indicator 58 could mean that sending chat partner 32 is on-line, a red colored status indicator 58 could mean that sending chat partner 32 is off-line, and a white colored status indicator 58 could mean that sending chat partner 32 is on-line, but away from computerized system 10.

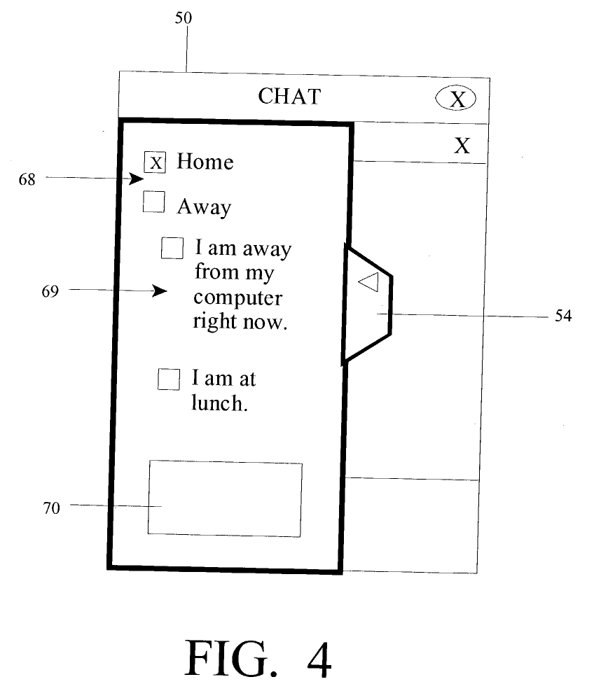

Similar to list tab 52, selection of status tab 54 will cause status tab 54 to expand, as shown in FIG. 4. Once expanded, sending chat partner 32 can select a particular status. As depicted, sending chat partner 32 is presented with a set of status options 68. Such options allow sending chat partner 32 to select whether he/she is “home” or “away” from computerized system 10. If sending chat partner 32 selects away, he/she can also designate a particular away message 69 that will be displayed to any other chat partner who tries to communicate with him/her. Tab 54 also includes message area 70 to allow sending chat partner 32 to manually designate a message in the event none of the preset away messages 69 are suitable. For example, the manually designated message could indicate that sending chat partner 32 is “out to lunch.” Conversely, the manually designated message could merely indicate a location of sending chat partner 32 (e.g., “I am at the beach, start chatting”).

Referring back to FIG. 2, chat tab 56 includes a set of chat indicators 60, which each correspond to an active chat between sending chat partner 32 and one or more receiving chat partners. Specifically, chat indicators 60 each represent one active chat that sending chat partner 32 is currently holding. To this extent, each chat indicator 60 could correspond to one of receiving chat partners 36 (e.g., Alice), 40 (e.g., Dan), 44 (e.g., Javier) and 48 (e.g., Glen) of FIG. 1. As will be further described below, the appearance of chat indicators 60 can be changed/altered to reflect various features such as a status of a particular active chat, such as the receipt of new chat material from a particular receiving chat partner.

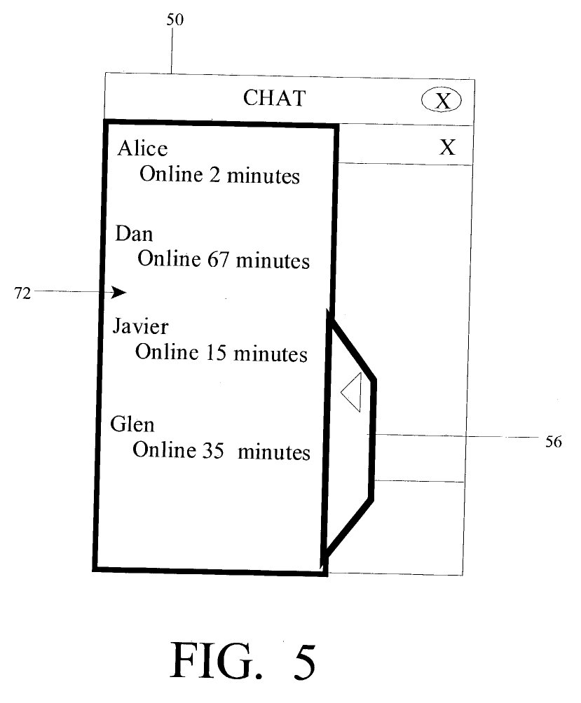

As shown in FIG. 5, upon selection, chat tab 56 will expand to reveal information 72 pertaining to each receiving chat partner engaged in an active chat. As shown, information 72 includes the name and time on-line for each receiving chat partner. It should be understood, however, that any type of information could be displayed upon selection of chat tab 56 and that the information depicted herein is intended to be illustrative only. In addition, links or buttons could be provided for each receiving chat partner that, when selected, displays his/her available user profile.

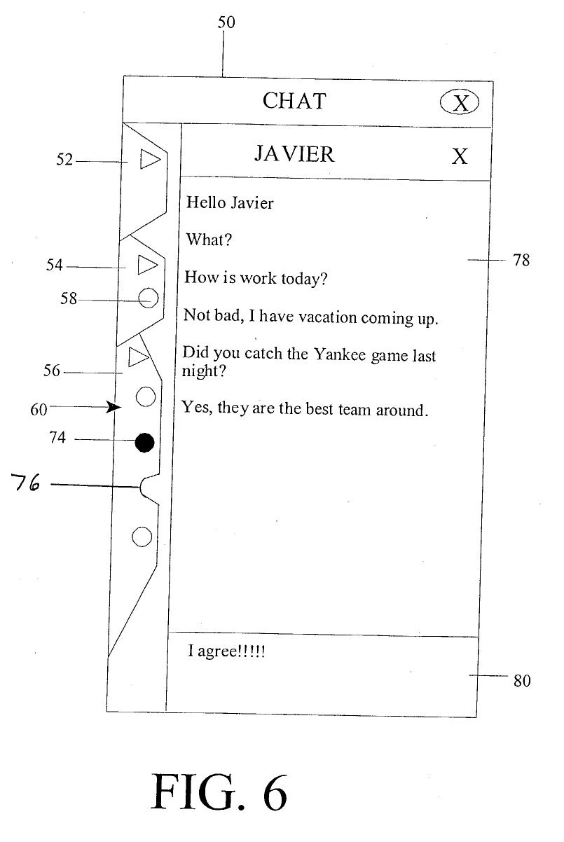

Referring to FIG. 6, user interface 50 as used to conduct chats is shown in greater detail. As depicted, during a chat user interface 50 includes incoming message window 78 and outgoing message window 80. Incoming message window 78 is where all messages received from the receiving chat partner are displayed. Outgoing message window 80 is where sending chat partner 32 will input his/her messages to receiving chat partner. As indicated above, under the present invention these same windows are used for all active chats. In other systems, a separate interface/window set was spawned for each active chat. Thus, if sending chat partner had four active chats simultaneously, four interfaces would be displayed.

In any event, FIG. 6 also shows chat tab 56 and chat indicators 60 in greater detail. As indicated above, chat indicators 60 each pertain to a single active chat between sending chat partner 32 and a receiving chat partner. In a typical embodiment, chat indicators 60 will be changed/varied to reflect the presence of new chat material in an active chat that is not currently being viewed by sending chat partner 32. For example, the active chat currently being viewed by sending chat partner 32 is occurring with receiving chat partner “Javier.” However, as can be seen, chat indicator 74 (e.g., pertaining to the active chat being held with “Dan”) has been changed (e.g., changed to the color red). This indicates that sending chat partner 32 has just received a new message (e.g., line of text) from “Dan.” This feature is especially valuable since it is well known that chats often occur with large time breaks between “conversation.” Moreover, chat indicators 60 allow sending chat partner 32 to stay current with each receiving chat partner when multiple active chats are being held. If after seeing chat indicator 74 change, sending chat partner 32 wishes to view the new chat material from “Dan,” he/she can click/select chat indicator 74. Upon selection, the new material from “Dan” will be displayed for sending chat partner 32 in incoming message window 78, and chat indicator 74 will revert back to its original form (e.g., the color white). As indicated above, any indicators shown herein such as chat indicators 60 could be animated. For example, if “Dan” has entered a new line of text for sending chat partner 32, but has not yet sent the new line of text, chat indicator 74 could flash/pulse, until the text has been sent.

As further shown, chat tab includes indentation or marker 76 below status indicator 74 (where a third chat indicator is positioned in FIG. 2). Indentation 76 indicates which active chat is currently being viewed by sending chat partner 32. For example, in FIG. 2, four chat indicators are displayed to indicate the presence of four active chats. For example, the first (top) status indicator could pertain to “Alice.” The second status indicator could pertain to “Dan.” The third status indicator could pertain to “Javier.” The fourth status indicator could pertain to “Glen.” Since the chat with “Javier” is currently being viewed in FIG. 6, indentation 76 appears where his chat indicator should be. “Javier's” chat indicator is not needed since any new chat material will be immediately viewable in incoming message window 78. If sending chat partner wishes to “switch” to another active chat, he/she can do so by selecting any of the other visible chat indicators. Upon selection, indentation 76 will appear where the selected chat indicator appears, and “Javier's” chat indicator will reappear.

Thus, tab-based user interface 50 of the present invention allows display space on any computerized device to be optimized. This is especially beneficial on smaller, hand-held devices. It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, list system 26, status system 28 and activity system 30 of FIG. 1 are separately shown and described as separate systems for illustrative purposes only. Such systems could easily be implemented as a single system or in any other quantity of systems. Moreover, although user interface 50 is shown as including all three tabs 52, 54 and 56, user interface 50 could actually be implemented with any single tab or combination of tabs. For example, user interface 50 could be implemented solely with chat tab 56.

We claim:

1. A user interface for conducting chats over a network, comprising a chat tab for revealing information pertaining to a set of active chats between a sending chat partner and a set of receiving chat partners, wherein the chat tab includes a set of chat indicators corresponding to the set of active chats.

2. The user interface of claim 1, further comprising:
a list tab for revealing a list of receiving chat partners and a status of each of the receiving chat partners in the list; and
a status tab for selecting a status of a sending chat partner.

3. The user interface of claim 2, wherein the status tab includes a status indicator for indicating the status of the sending chat partner.

4. The user interface of claim 1, wherein one of the set of chat indicators can be selected to view an active chat that corresponds to the selected indicator.

5. The user interface of claim 1, wherein an appearance of each of the set of chat indicators is alterable to reflect a reception of new chat material.

6. The user interface of claim 1, wherein the chat tab further includes an indentation that corresponds to an active chat currently being viewed.

7. The user interface of claim 1, wherein the information is revealed upon selection of the chat tab, and wherein the information comprises a name of each receiving chat partner participating in one of the set of active chats.

8. A user interface for conducting chats over a network, comprising:
a list tab for revealing a list of receiving chat partners and a status of each of the receiving chat partners;
a status tab for selecting a status of a sending chat partner, wherein the status tab includes a status indicator for indicating the status of the sending chat partner; and
a chat tab for revealing information pertaining to a set of active chats between the sending chat partner and the receiving chat partners, wherein the chat tab includes a set of chat indicators corresponding to the set of active chats.

9. The user interface of claim 8, wherein one of the set of chat indicators can be selected to view an active chat that corresponds to the selected indicator.

10. The user interface of claim 8, wherein an appearance of each of the set of chat indicators is alterable to reflect the reception of new chat material.

11. The user interface of claim 8, wherein the chat tab includes an indentation that corresponds to an active chat currently being viewed.

12. The user interface of claim 8, wherein the information is revealed upon selection of the chat tab, and wherein the information comprises a name of each receiving chat partner participating in one of the set of active chats.

13. A system for generating a user interface for conducting chats over a network, comprising:
a list system for generating a list tab for revealing a list of receiving chat partners and a status of each of the receiving chat partners;
a status system for generating a status tab for selecting a status of a sending chat partner; and
an activity system for generating a chat tab for revealing information pertaining to a set of active chats between the sending chat partner and the receiving chat partners.

14. The system of claim 13, wherein the status tab includes a status indicator for indicating the status of the sending chat partner.

15. The system of claim 13, wherein the chat tab includes a set of chat indicators corresponding to the set of active chats.

16. The system of claim 15, wherein one of the set of chat indicators can be selected to view an active chat that corresponds to the selected indicator.

17. The system of claim 15, wherein an appearance of each of the set of chat indicators is alterable to reflect the reception of new chat material.

18. The system of claim 13, wherein the chat tab includes an indentation that corresponds to an active chat currently being viewed.

19. The system of claim 13, wherein the information is revealed upon selection of the chat tab, and wherein the information comprises a name of each receiving chat partner participating in one of the set of active chats.

20. A program product stored on a recordable medium for generating a user interface for conducting chats over a network, which when executed comprises:
program code for generating a list tab for revealing a list of receiving chat partners and a status of each of the receiving chat partners;
program code for generating a status tab for selecting a status of a sending chat partner; and
program code for generating a chat tab for revealing information pertaining to a set of active chats between the sending chat partner and the receiving chat partners.

21. The program product of claim 20, wherein the status tab includes a status indicator for indicating the status of the sending chat partner.

22. The program product of claim 20, wherein the chat tab includes a set of chat indicators corresponding to the set of active chats.

23. The program product of claim 22, wherein one of the set of chat indicators can be selected to view an active chat that corresponds to the selected indicator.

24. The program product of claim 22, wherein an appearance of each of the set of chat indicators is alterable to reflect the reception of new chat material.

25. The program product of claim 20, wherein the chat tab includes an indentation that corresponds to an active chat currently being viewed.

26. The program product of claim 20, wherein the information is revealed upon selection of the chat tab, and wherein the information comprises a name of each receiving chat partner participating in one of the set of active chats.

27. A method for generating a user interface for conducting chats over a network, comprising:
generating a list tab for revealing a list of receiving chat partners and a status of each of the receiving chat partners;
generating a status tab for selecting a status of a sending chat partner; and
generating a chat tab for revealing information pertaining to a set of active chats between the sending chat partner and the receiving chat partners.

28. The method of claim 27, further comprising providing a status indicator on the status tab for indicating the status of the sending chat partner.

29. The method of claim 27, further comprising providing a set of chat indicators on the chat tab corresponding to the set of active chats.

30. The method of claim 29, further comprising selecting one of the set of chat indicators to view an active chat that corresponds to the selected indicator.

31. The method of claim 29, further comprising altering an appearance of one of the set of chat indicators to reflect the reception of new chat material.

32. The method of claim 27, further comprising providing an indentation in the chat tab that corresponds to an active chat currently being viewed.

33. The method of claim 27, wherein the information is revealed upon selecting the chat tab, and wherein the information comprises a name of each receiving chat partner participating in one of the set of active chats.
